(19) United States
(12) Patent Application Publication
(10) Pub. No.: US 2012/0150561 A1
(43) Pub. Date: Jun. 14, 2012

(54) Prescription Verification System

(76) Inventors: Sean Carroll, Trent Woods, NC (US); Christopher Hoeler, Phoenix, AZ (US)

(21) Appl. No.: 13/270,508

(22) Filed: Oct. 11, 2011

Related U.S. Application Data
(60) Provisional application No. 61/421,469, filed on Dec. 9, 2010.

(51) Int. Cl. G06Q 50/24; G06Q 50/10

(52) U.S. Cl. 705/3; 705/2

(57) ABSTRACT

A centralized verification system and method is provided that stores and processes information on a secure remote server database for verifying medical prescription orders originating from healthcare providers. A secure interactive website resides on a remote server with a unique URL address, enabling one or more clients to retrieve medical prescriptions originated and for ordering personnel information for prescription verification through the internet by use of a general purpose computer. Access is limited to medical and pharmacy personnel having a validated and authorized identification and access code. The system includes functionality for entering, editing, or deleting data files and retrieving and displaying them as requested by authorized users as they pertain to ordering and filling of medical prescriptions.

### CROSS-REFERENCE TO RELATED APPLICATIONS

This application claims priority and is related to U.S. Provisional Patent Application Ser. No. 61/421,469, filed Dec. 9, 2010; the disclosure of which is incorporated by reference in its entirety.

### BACKGROUND OF THE INVENTION

1. Technical Field

The invention disclosed herein relates generally to a pharmacy internet information system, a method for verifying medical prescription orders originating from authorized healthcare providers, and to providing systems and methods related thereto. More particularly, the system and method allows access by authorized users to a secure central remote server via the internet for entry and retrieval of vital information for validating and/or verifying medical prescription orders.

2. Background Art

In most current prescription environments, pharmacies require either a written prescription authorized by the signature of a licensed physician which is presented at the store counter, or a telephone order with direct contact validation over the telephone from a licensed physician's office before a prescription can be filled. In the event a prescription is called in through the phone to a pharmacy, the pharmacist has no means of easily verifying that the person placing the order is authorized to do so, or even if the prescription is authentic.

If a prescription is presented at the pharmacy counter without the originator's DEA, NPI or state license numbers, the pharmacist also has no simple way of verifying the information. The only validation protocol currently available is required contact by telephone for every order received. This results in a time consuming process and the pharmacy must contact the healthcare provider office during normal office hours. As such, this prevents validation of prescriptions at times other than normal business hours.

One attempted solution to the problems discussed is disclosed in U.S. Pat. No. 5,845,255 which relates to a prescription management system. A wirelessly deployable, electronic prescription creation system is provided for physicians use. The system captures into a prescription a patient condition-objective of the prescribed treatment, and provides for patient record assembly from source elements, with privacy controls for patient and doctor, adverse indication review and online access to comprehensive drug information. While such a system is useful from a patient management perspective, it fails to provide a secure verification system for use in communications between a healthcare provider and a pharmacy.

U.S. Patent Publication No. 2006/0064326 discloses a system and process for prescribing medications through the internet. The system includes a secured, interactive website for entering and retrieving medical prescriptions. The website is accessible via the internet at a unique URL address by a general use computer. Access by medical personnel may be limited by requiring an authorized ID code and by pharmaceutical personnel also being required to have an ID code. The pharmacies can be selected by the physician so that the physician can enter a prescription into the secured website of the medical prescription service. The pharmacy selected by the patient can access the medical prescription service website, located in the patient's record, obtain the prescription and fill the prescription. However, such a system is still complicated and requires a departure from what is now the more traditional process of calling in a prescription by medical personnel or presenting a written prescription to a specific pharmacy.

As such, there remains a need for systems and methods which allow traditional call in of and drop off of written prescriptions to be implemented in a secure and verifiable manner.

### BRIEF SUMMARY OF THE INVENTION

According to one embodiment of the present invention, a prescription verification system is provided wherein the system includes a secure website configured for managing information relating to medical personnel, pharmacies and patients. A first portion of the secure website serves to create and allow access to created individual medical personnel files. A second portion of the secure website serves to create and allow access to created individual pharmacy files and a third portion of the secure website serves to create and allow access to created individual patient files. The website is further configured for assigning and displaying unique codes for authorized users of the secured website. This allows, for example, verification of called in prescription information, for example, by the medical personnel providing an ID code which verifies the authority to order the prescription, and which can be searched on the website by a pharmacy having access through a general purpose computer connected to the internet.

Preferably, the communications with the website include an encryption function and only individuals having an authorized code can access the website. Other features can be added to make the website more user friendly.

In an alternative aspect there is provided a computer implemented method of verifying prescription information. The method involves providing an interactive secure website configured for managing information relating to medical personnel, pharmacies and patients. Medical practices may be registered at the website, along with all medical practice staff authorized to call in prescriptions. During registration, a unique medical staff identification code is assigned for each medical staff member. Similarly, pharmacies can be registered in the same manner and all pharmacy staff authorized to verify call in prescriptions are assigned a unique pharmacy staff identification code. Verified prescriptions are properly filled by only allowing call in prescriptions by authorized medical prescription staff, and verification by pharmacy staff which present their respective identification codes, which are then verified by access to the secure website by the pharmacy staff. Yet, still further, the website can have an image repository for allowing comparison of signatures on dropped off written prescriptions for verification purposes.

In a yet further aspect, there is provided a centralized system for verifying medical prescriptions through the internet. An interactive website is provided on a server which is accessible via the internet through computers, for storing and retrieving medical provider information for use in verification of prescription orders. The website is configured for allowing access only through secure communications by pharmacy and medical personnel having authorized identification codes. The website is further configured for creating business accounts for pharmacies and medical personnel, and configured for editing the accounts by authorized personnel.

The website can be further programmed to allow entry of fraud incidents experienced by authorized personnel.

As may be appreciated in accordance with the above-described systems and methods, an easy, secure and effective method for pharmacy/medical provider partnership is provided which allows verification of medical prescriptions throughout the day, while reducing the manpower and time necessary to complete the verification. In practice, pharmacies and medical practices subscribe to the secured website as a way of implementing the system and method.

An object of the present invention having been stated hereinabove, and which is addressed in whole or in part by the present invention, and other objects will become evident as the description proceeds when taken in connection with the accompanying drawings as best described hereinbelow.

### BRIEF DESCRIPTION OF THE DRAWINGS

FIG. 1 is a block diagram illustrating how a business account is established with the system and method of the invention;

FIG. 2 is a block diagram illustrating how access to the secure website of the invention is conducted by a pharmacy and by a medical practice through use of general purpose computers connected to the internet;

FIG. 3 is a block diagram illustrating how administrators and clients subscribe to the secure website, and are allowed encrypted administrative level access to the website for modification of client information at the secure website;

FIG. 4 is a block diagram illustrating how physicians, pharmacists, and staff users may be registered for allowing access to the website; and

FIG. 5 is a block diagram illustrating how a pharmacy staff user accesses and uses the website.

### DETAILED DESCRIPTION OF THE INVENTION

Prior to continuing with the detailed description of the invention, the following definitions are provided to facilitate an understanding of the system and method described herein.

WEBSITE means a connected group of pages on the World Wide Web, regarded as a single entity, usually maintained by one person or organization and devoted to a single topic or severally closely related topics.

WEBPAGE means a document on the World Wide Web consisting of an HTML file and any related files, and often hyperlinked through other documents on the World Wide Web. The content of webpages is normally accessed by using a web browser.

WEB BROWSER means a program that accesses and displaces files and other data available on the internet and other networks.

URL means an internet address usually consisting of the access protocol (“http”), the domain name, and optionally the path to a file or resource residing on that server.

INTERACTIVE means of or relating to a program that responds to user activity.

SERVER means a computer that controls a central depository of data that can be manipulated in some manner by a client.

ENCRYPTION means to alter information using a code or mathematic algorithm so as to be unintelligible to unauthorized readers.

FTP means a communication protocol governing the transfer of files from one computer to another over a network.

ISP means internet service provider, which is a business providing connection to the internet and other related services.

By way of further explanation, a medical practice is one type of organization that may subscribe to the system and method of the invention. The medical practice registers the practice with the website and provides pertinent information about the practice and the associated primary healthcare providers (PHP), and registers all staff members authorized to order prescriptions. Each prescription orderer is assigned a unique ID number. The unique ID number may be made up of a letter character prefix and a numerical integer, by the website. The ID numbers are unique to each individual authorized to order prescriptions by the medical practice, are not public knowledge, are not written down anywhere, and are password protected.

When a staff member authorized to order prescriptions phones in a prescriptions order (prescription caller), they state their name, provider's name they represent, practice name and their ID number. This information is used in the verification process on the pharmacy side for phone-in orders.

When originating a written prescription, the provider may log the amount, type of medication, recipient and date into the medical practice's daily prescription log. The daily prescription log may be accessible by a pharmacy user to validate the prescription details and expose prescription alterations. Written or computer-generated prescriptions may be printed on tamper-proof prescription paper, and may include a unique barcode. Prescription details may be listed under the unique barcode and stored in a database for access by the pharmacy user by scanning the prescription barcode of a prescription presented in-store or drive-thru.

To implement the subscription, information about the medical practice, primary healthcare provider information and license data needs to be entered only once into the system. It can be updated as needed and pharmacies will have access to the information through the website instead of direct phone contact, unless a discrepancy is detected, fraud is suspected, or information is not presented. Phone contact is not needed to validate every medical prescription, saving time and valuable manpower.

On the pharmacy side, each pharmacy subscribes to the website and registers all authorized pharmacy users who verify the orders. When a phoned-in prescription order is received, the pharmacy user enters the stated ID into the search form at the website. If the ID number is valid, the prescription caller's name and matching ID number will be displayed with associated provider information, which may include a practice name, address, phone number, primary healthcare providers and their DEA, NPI and state license number. The information may be compared to the data stated in the phone order, or indicated in an electronic prescription order, and authenticity can be verified.

Alternatively, if a prescription is presented in the store but does not include all DEA, NPI and/or state license numbers, the pharmacy user may enter the medical practice or individual provider name into the respective search form. If the entered medical practice or provider is a subscriber to the website, the name, medical practice info and DEA, NPI and state license numbers will appear. The information can be used to contact the healthcare provider office for validation of the order.

Prescriptions may also be printed on tamper-proof prescription paper, which may include a unique barcode. A prescription printed on such tamper-proof prescription paper may be searched and verified by a pharmacy user scanning the barcode on the prescription and retrieving all the prescription information as written and uploaded by the provider.

A pharmacy may also enter the medical practice's business name into the search form to retrieve a direct email link to communicate directly with a registered medical practice and/or access the medical practice's prescription log.

An advantage to the invention is that no more searches of multiple sites for DEA, NPI, state license numbers and office contact information is required, thereby reducing time consumed in filling the prescription. Direct phone contact with healthcare providers is only necessary when a discrepancy is detected, fraud suspected or information is not presented.

As may be appreciated by those of ordinary skill in the art, the website may be used for storage and retrieval of information. New functions and uses of the website can be further developed based on the description herein, and resulting from customer feedback and industry needs. Further functionality may include nonverbal communications between pharmacy and healthcare providers using, for example, email, texting, or other suitable technologies. The website may further provide for display of real-time data and images (e.g., scanned images of written prescriptions) for written prescription validation. Other uses may involve collection and display of attempted prescription fraud techniques circulating throughout the industry, as well as through access to reports of illegal drug diversion news from around the world, and links to pharmacy to provider responsibility and liability information. The system and method may also be used for business management techniques. Obviously, the design of graphics, functions and databases via software can take many forms so long as the basic functionality for the description of information collection and retrieval for the pharma-medical industry is maintained.

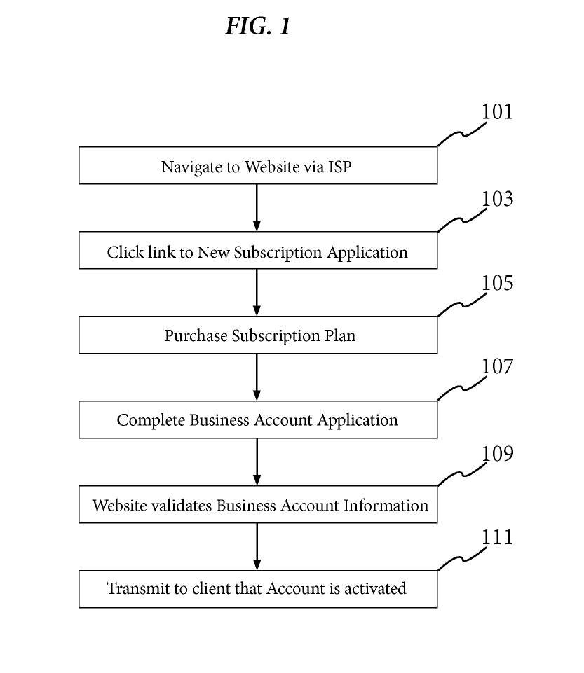

In reference to FIGS. 1-5, the preferred embodiments of the present invention are illustrated and include all solid arrows representing directional data flow, with dashed arrows representing encrypted data flow. The system and method provides verification of medical prescription orders received by pharmacies over the phone or via over-the-counter pick up. An internet based validation service website is provided which is accessible to authorized users for entering and retrieving prescription information.

The website typically includes a set of interconnected webpages located on a central server accessible on the internet by use of its URL address. The system is secured so only authorized users with proper identification can enter the secured pages of the website and access features thereof. Healthcare providers who originate medical prescriptions can enter all pertinent information needed to confirm prescription orders, and pharmacists can access that information to validate and verify all prescription orders.

In terms of the specific working of the system, users of the system and methods are preferably limited to clients who are licensed physicians, their authorized staff, and licensed pharmacists and their authorized staff. By the term licensed physicians is meant physicians licensed by a state board to practice medicine. By the term licensed pharmacists is meant a pharmacist licensed by a state board to dispense medications with a physician order. In a preferred aspect, access and authorization to use the system and methods is done by registration of a business account.

The website may include login pages stored on a server and accessible to the general public through the internet. On the other hand, database searches, member information, physician pharmacy data entry forms, and informational databases stored on the secure remote server are only accessible to authorized users and all communications with this secured remote server are encrypted for security.

Referring now to FIG. 1, there is shown a block diagram illustrating how a business account is established. Generally speaking, a licensed physician or pharmacist (“client”) may initiate an application to enroll their practice or pharmacy in the system through its homepage on the internet, which is accessible to the public at a specific URL. This is done at Step 101 as illustrated in FIG. 1. The potential client accesses the website homepage using a unique URL address, and clicks on a register now link 103 to begin the business application process. In a preferred embodiment, the subscription plan selected may be purchased 105, for example, through an entity such as PayPal® or any other suitable payment means. The business account application may then be completed 107. The website then validates the business account information 109 and transmits a message to the client indicating that the account is activated 111.

In implementing the steps of FIG. 1 the client chooses the subscription plan that fits their practice or pharmacy needs prior to clicking “subscribe.” If an entity such as PayPal® is used as the payment website, payment for the service is made through the payment website's secure financial transaction system. When completing the application form, the username entered must be unique to the database. If not, the username may be denied and a new username requested. The validation step 109 may be conducted using on-line resources and direct contact with the applying businesses.

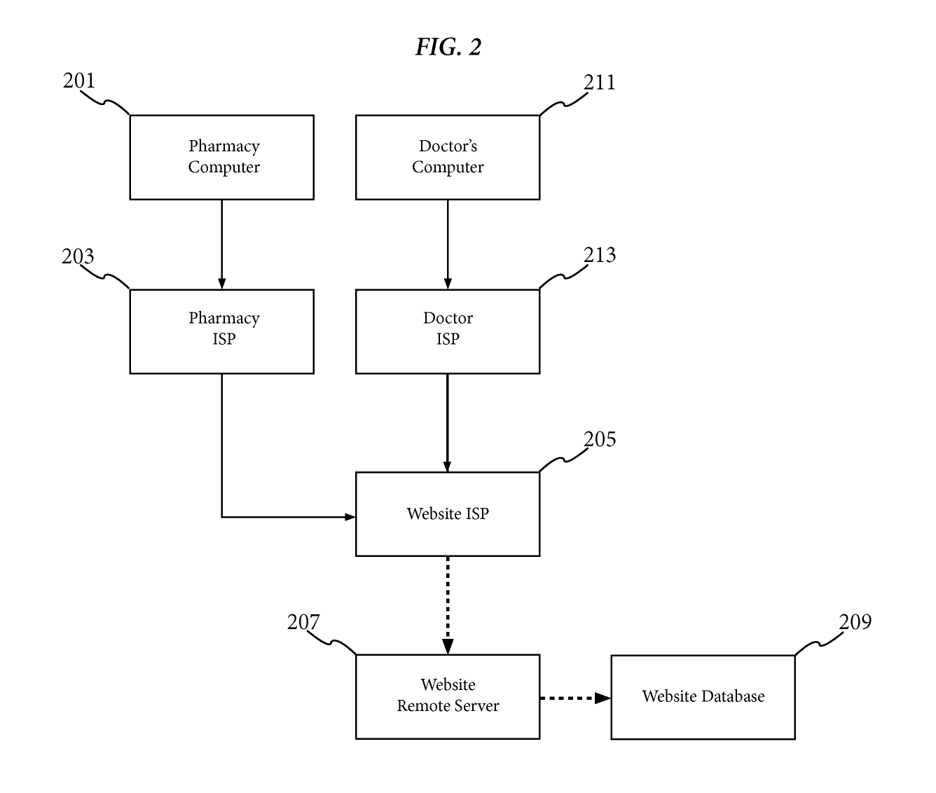

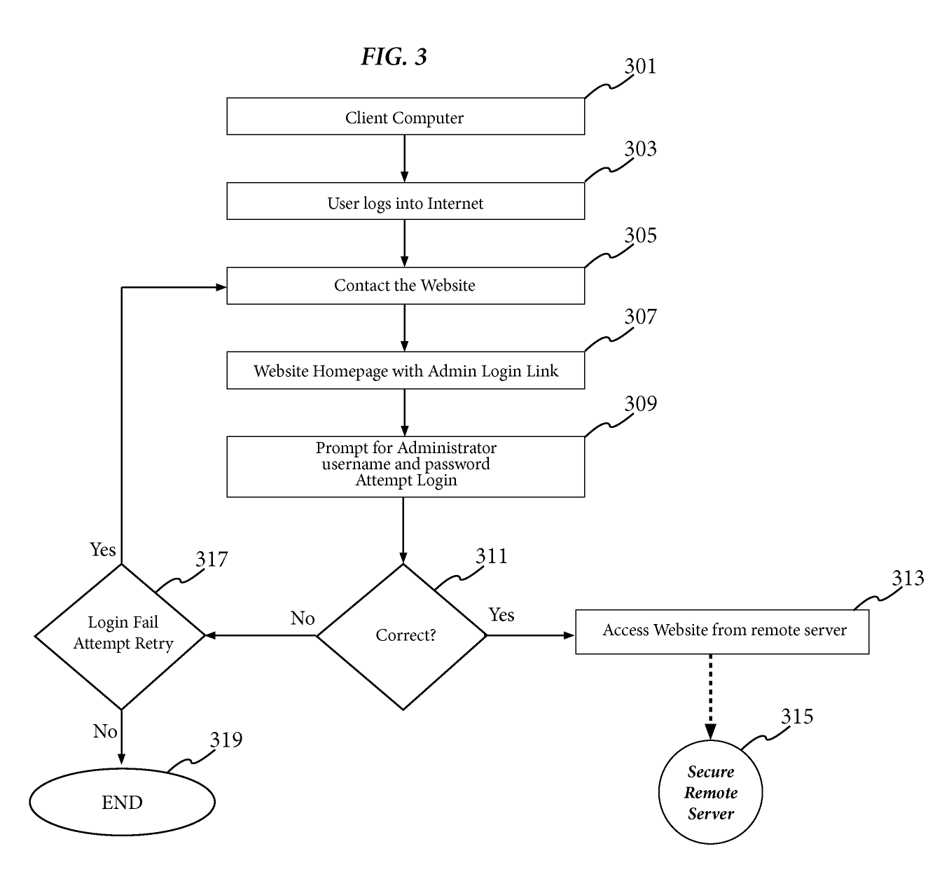

A notification 111 of a successful application may occur through email which is part of the information entered in the application. Thereafter, upon receipt by the website of the validation email, the business account will be activated with administrative secure access. The username and password for administrative access is only good for managing the licensed physician or pharmacist business account as more clearly shown in FIG. 3. Access to search features of the website may require separate pharmacy staff usernames and passwords as described, as well as physicians' staff usernames and passwords, as shown in FIGS. 2, 4, and 5.

When the licensed physician or pharmacist (“client”), has established a validated secure administrator login, the website may be accessed and the business account information managed. In addition, staff members may be registered. This is further illustrated in FIG. 2. The client may access the internet through their own computer at steps 201 or 211, respectively. The computer is connected to their respective ISPs 203, 213 which then connect through the system's website ISP 205 to the website remote server 207 through encrypted communications as shown by the dashed lines, accessing the server 207 then provides access, through encrypted communications, to the website database 209.

The website for the information system is typically located on a secure, central remote server accessed by contacting its numerical ISP address. The server computer is permanently connected to the internet and is a centralized hub for other computers desiring access to the website.

As shown in FIG. 3, access to the secure remote server is only available to clients with a secure, encrypted administrative level passcode established in the initial account application as established in FIG. 1. The client, using their computer 301 accesses the internet 303 and navigates to the website. A connection is established at the website 305 and shows a website homepage with an administrative login link 307. Clicking on the administrator login link, the client connects to the business administration login page 309 which requires the username and password setup with the initial business account application for membership. If the information entered is correct 311, then access to the website from the remote server is provided 313 and the client can connect to the secure remote server 315. If the information entered is incorrect in step 311, the login fails 317 and an attempt to login can again be initiated at step 305. Alternatively, if the login fails without a retry, the process ends at step 319.

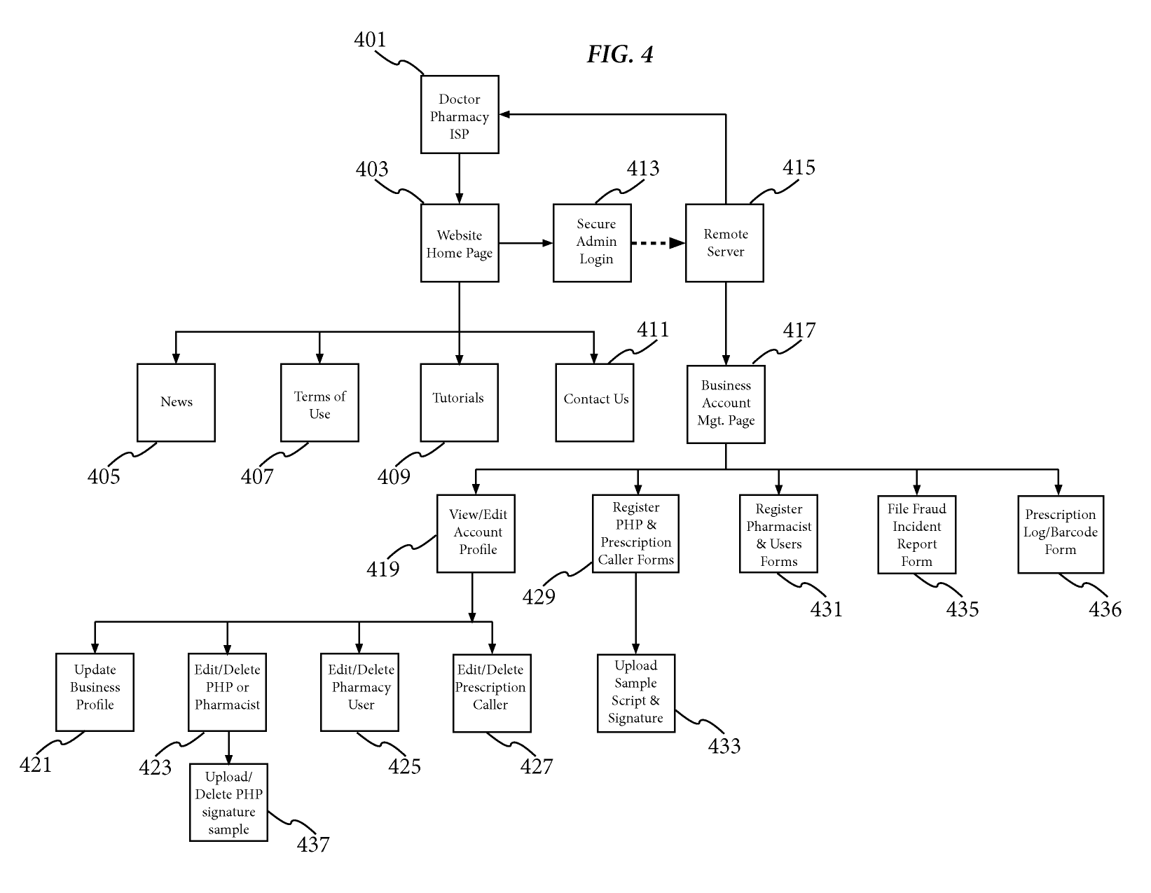

Once the administrative account is set up, physicians, their staff, pharmacists and pharmacy staff users may be registered at the website, as illustrated in FIG. 4. Access is through the doctor or pharmacy ISP 401 which connects to the website homepage 403. The users may be allowed access to a news webpage 405, terms of use 407, tutorials 409, or a contact portion 411 of the website. Alternatively, the administrator can login at a secure login page 413 which connects to a remote server 415 and directs the administrator to the business account management page 417. At that page, a number of additional options may be presented, for example, viewing or editing the account profile 419; registering primary healthcare providers and physician staff users 429; registering pharmacists and pharmacy staff users 431; if a fraudulent transaction is suspected, reporting a fraud incident report through a form at a fraud page presented in step 435; and/or enter the prescription log information and barcode link 436.

If the account profile is viewed or edited 419, various options may also be presented, for example, updating the business profile 421, editing or deleting a primary healthcare provider or pharmacist 423, editing or deleting a pharmacy user 425, or editing or deleting a prescription caller 427. If registering of the primary healthcare provider and prescription caller forms is desired at step 429, then at step 433 an upload sample prescription and signature may be provided to allow comparison and verification of a written prescription by a pharmacy user when presented with a written or printed prescription.

By way of further clarification, the view/edit account profile step 419 serves to display and manage the business account. The link directs the client to a business account profile data results page that lists information specific to their business account and allows them to manage the information. Such information includes name, address, phone/fax numbers, email address and URL of the account. By clicking a submit updates button (not shown), revised information is saved and the system returns to the business account profile page to check for the accuracy of the updates.

At step 429, the primary healthcare provider and staff users may be registered. This link will typically take the client to an add primary healthcare provider or staff users page with two tab forms. The client then clicks on the tab for the desired registration form. If prescription originators (e.g., PHPs) or prescription order callers are to be registered or updated, at step 429 the user is prompted to enter all information requested in the required form fields to register personnel who are authorized to call in medical prescription orders. The website will generate a random unique ID for each individual prescription caller registered and they will be listed on the business account profile page accessible only by the administrator. A notification, such as an email, is then sent to the registered prescription caller to inform them of their assigned ID, such as a number or prefix and numerical integer to use when calling in prescription orders.

For a new primary healthcare provider, all information is typically entered in the required form fields to register personnel who are authorized to originate prescription orders. The personnel who are authorized to originate prescription orders are preferably listed on the business account profile page and the search results page as a result of a search inquiry. The number of staff which may be entered is preferably not capped. Inaccuracies can be edited by clicking on the ID number of the affected profile.

At step 431, the pharmacist and pharmacy staff users may be registered. This link will typically take the client to an add pharmacy staff or pharmacist page and may include a two tabbed form, for example, one for add pharmacy staff and one for add pharmacist. The client then clicks on the tab for the desired registration form. For new pharmacy staff, all information is typically entered in the required form fields to register personnel who are authorized to access the website to conduct searches of prescription originators and callers. A similar process is followed for new pharmacists to be added. Likewise, the number of staff that may be added is preferably uncapped and inaccuracies found can be edited.

There is also provided a link 435 for reporting fraud incidents. This link is used to report fraud schemes and attempts experienced by the physician office or pharmacy.

As previously discussed, there is provided a link 433 for providers to upload a sample written prescriptions with authorized signatures for allowing comparison to written prescriptions presented to the pharmacy at, for example, an in-store counter or drive-through window. The provider can scan a copy of a voided sample prescription complete with the provider's signature in JPG, or other suitable format. The provider may then navigate to the signature verification setup page and upload the scanned in voided sample prescription with the provider's signature to be used for verification purposes. The image of the uploaded sample prescription with signature is then available to pharmacy users for verification purposes. A pharmacy user may access the uploaded sample prescription by using a form on the main search page. When the search results are received, the pharmacy user selects the particular provider's ID number for an image of the sample prescription and signature for comparison to verify a presented prescription.

There is also provided link 436 for providers to upload a prescription log entry linked to a specific prescription barcode, this link takes the provider to a prescription log page. The prescription is written by the provider either by hand or printed through a computer system and printer. The provider navigates to the prescription log page, scans a barcode specific to the written prescription into the database and uploads a scanned image of the specific prescription under that specific barcode reference. The information is then available for access by a pharmacy user to verify all details of a written prescription presented at the pharmacy, e.g., at the pharmacy counter or drive-thru window.

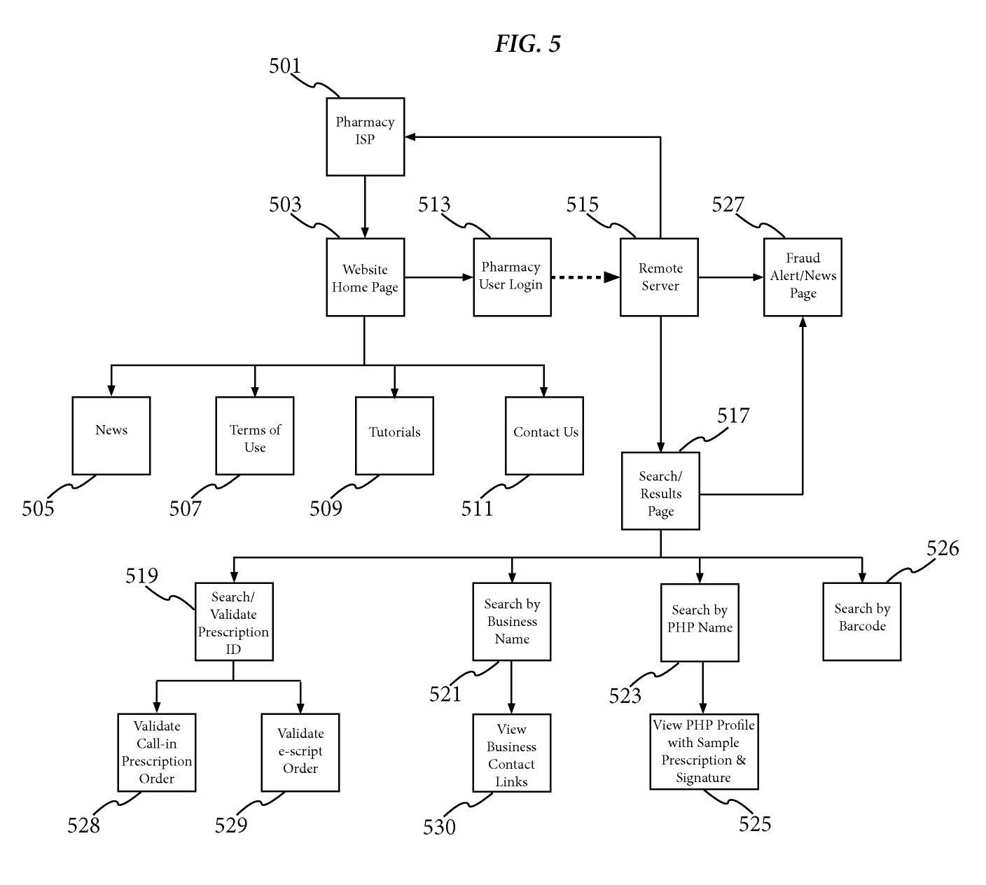

Turning now to FIG. 5, there is illustrated how a pharmacy staff user accesses and uses the system. The user, using their computer, accesses the internet and contacts the website through the pharmacy ISP 501 to arrive at the web site homepage 503. From that web site homepage 503, a number of other pages can be accessed such as a news page 505, terms of use 507, tutorials 509 or a contact page 511. Alternatively, the pharmacy staff user may directly login 513 for encrypted access to a remote server 515 for conducting a search and obtaining results page 517. The searches can include searching and validating the prescription caller identification 519 including validating a call-in prescription order 528 or an electronic prescription order 529, searching by business name 521 to view business contact links 530 (e.g., to contact a provider by email), searching by primary healthcare provider name 523 which then may further include viewing a sample prescription and signature 525, or searching by barcode 526. Finally, a pharmacy staff user can also navigate from the search page 517 or directly through access from the remote server 515 to a fraud alert and news page 527 which contains links to articles, government documents and ongoing court cases and recent decisions, as well as other fraud related incident scheme reports from, for example, colleagues around the industry which may be posted.

Discussing FIG. 5 in greater detail, a number of different options are presented in the secure area of the remote server. In the search/validate form 519, the client user may enter the numerical integer of the prescription caller ID number provided in the phoned-in or electronic prescription order in the field of this form and clicks search to facilitate validating call-in prescription 528 or electronic prescription 529. If the entered numerical integer corresponds to a valid registered prescription caller, the prescription caller ID number with the current prefix and numerical integer will appear as well as, for example, the name, address, phone number and email address of the associated practice with this prescription caller. All of the primary providers at this practice will be listed with their DEA, NPI and license numbers, and other contact information. The user then compares and validates that all the information returned in the search matches information stated by the prescription caller when the prescription order was placed. If the ID number search is not a valid registered prescription caller, the results page will be blank and this indicates that a possible fraud scheme may have been attempted. The prescription request should be held until the pharmacy can contact the healthcare provider office to verify legitimacy. If the provider cannot verify the order as legitimate or a mistake was made, the pharmacy may inform the provider of a fraud attempt in the prescription order.

With respect to searching by business name 521, particular medical practices may be searched on the website when no prescription caller ID number is given in a phone-in order. These search results are limited to valid registered medical practices. The user may enter the medical practice name or type in the form and click search. If the practice name entered is a valid registered member, information about the member will appear, e.g., view business contact links 530, and the user can contact the provider if listed to verify prescription orders or to report a fraud attempt. If the name of the provider is not a valid member, the results page is shown as blank and this indicates that a possible fraud scheme has been attempted.

A search may also be conducted by a primary healthcare provider name at step 523. This search may be used, for example, by a pharmacy user to search for registered primary providers when a prescription is presented in-store or at drive-thru window. The name may be entered as shown on the prescription and a search conducted. If it is a valid provider member, the name, PHP profile, DEA, NPI and license numbers and other contact information will appear. At step 525, PHP profile and/or a written prescription with signature sample can be viewed. Alternatively, if the name search is not a valid member, a fraud report can be made.

A search may also be conducted by a prescription barcode at link 526. This search may be used, for example, by a pharmacy user to access a prescription log database via a prescription barcode when a prescription is presented in-store or at drive-thru window, and allows a pharmacy user to mark a specific barcode prescription as filled. The pharmacy user scans the barcode on the prescription and a search is conducted. If a valid barcode, the exact prescription, as scanned by the provider, will appear for the pharmacy user to view and compare to the prescription presented. If the prescription is valid, the pharmacist will fill the order and update the prescription status to “filled”. If the prescription is not valid, e.g., copied and filled at a different location, the prescription status will reveal the prescription was previously filled and indicate a fraud alert. Further, if the prescription barcode has been altered, it will be alerted as invalid and indicate a fraud alert.

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

What is claimed is:

1. A prescription verification system comprising:
(a) a secure website configured for managing information related to medical personnel, pharmacies and patients;
(b) a first portion of said secure website for creating and allowing access to created individual medical personnel files;
(c) a second portion of said secure website for creating and allowing access to created individual pharmacy files;
(d) a third portion of said secure website for creating and allowing access to created individual patient files; and
(e) said website further configured for assigning and displaying unique codes for authorized users of the secure website.

2. The system of claim 1, further comprising an encryption function to gain access thereto and further programmed for requiring individuals desiring to access the system to have an authorized code.

3. The system of claim 1, further comprising a server hosting the website, and accessible via the internet via respective individual medical personnel computers and individual pharmacy computers.

4. The system of claim 1, further programmed to display tutorials on use of the system.

5. The system of claim 1, wherein the unique codes for authorized users can be changed by such authorized users.

6. The system of claim 1, wherein the secure website and files can only be accessed through paid subscription.

7. The system of claim 1, further configured for storing a user profile at the secure website.

8. The system of claim 7, wherein said user profile is for a medical practice and includes license information.

9. The system of claim 8, further comprising a list of authorized individuals stored at the website who are authorized to provide a prescription.

10. The system of claim 9, wherein each authorized individual is provided with a unique code respectively.

11. The system of claim 1, further configured for entering, editing, or deleting data files.

12. The system of claim 11, wherein the data files comprise business, prescription, or personnel data.

13. The system of claim 1, further configured for storing prescription data at the secure website.

14. The method of claim 13, wherein stored prescription data is accessed by scanning a barcode associated with a specific prescription.

15. A computer implemented method of verifying prescription information, the method comprising:
(a) providing an interactive secure website configured for managing information relating to medical personnel, pharmacies and patients;
(b) registering medical practices and all medical practice staff authorized to order prescriptions at the website, and assigning a unique medical staff identification code for each medical staff member;
(c) registering pharmacies and all pharmacy staff authorized to verify ordered prescriptions at the website, and assigning a unique pharmacy staff identification code for each medical staff member; and
(d) verifying prescriptions by only allowing ordered prescriptions by authorized medical prescription staff and verification by pharmacy staff presenting their respective identification codes to verify authorization through access to the website.

16. The method of claim 15, further comprising accessing the secure website through a general purpose computer connected through the internet.

17. The method of claim 15, further comprising allowing access to the website through encrypted communications.

18. The method of claim 15, wherein said website is hosted at a secure server capable of being accessed by general purpose computers.

19. The method of claim 15, further comprising storing user profiles at the website for authorized users.

20. The method of claim 15, further comprising storing prescription data at the website.

21. The method of claim 20, wherein stored prescription data is accessed by scanning a barcode associated with a specific prescription.

22. The method of claim 15, further comprising allowing authorized users to access an email link to the registered medical practice

23. The method of claim 15, further comprising allowing authorized users to access a prescription log maintained by the medical practice.

24. A centralized system for verifying medical prescriptions through the internet, the system comprising:
(a) an interactive website on a server which is accessible via the internet through computers, for storing and retrieving medical provider information for use in verification of prescription orders;
(b) said website configured for allowing access only through secure communications by pharmacy and medical personnel having authorized identification codes; and
(c) said website being further configured for creating business accounts for pharmacies and medical personnel, and configured for editing said accounts by authorized personnel.

25. The system of claim 24, wherein said website presents internet links to at least one information database comprised of at least one of regulatory, drug diversion resources and a law enforcement database for regulatory resources.

26. The system of claim 24, wherein the website includes stored subscriber data in a database.

27. The system of claim 24, wherein the website is configured for requiring login and logoff to ensure security of authorized personnel information.

28. The system of claim 24, wherein the website is configured for requiring a minimum set of subscriber information to be entered before a valid account can be created.

29. The system of claim 24, wherein said website comprises an image store for storing images of signed prescriptions for validating prescriptions at a pharmacy counter.

30. The system of claim 24, wherein said website is configured for allowing entry and storage of fraud incidents experienced by authorized personnel.

31. The system of claim 24, wherein the website is configured for entering, editing, or deleting data files.

32. The system of claim 31, wherein the data files comprise business, prescription, or personnel data.
